(19) United States
(12) Patent Application Publication
(10) Pub. No.: US 2025/0328906 A1
(43) Pub. Date: Oct. 23, 2025

(54) ITERATIVE GRAPH EMBEDDING OF A BLOCKCHAIN NETWORK

(71) Applicant: Coinbase, Inc., Oakland, CA (US)

(72) Inventors: Ayush Agarwal, Balrampur (IN); Chaoqing Lu, Seattle, WA (US); Arjun Maheswaran, Bangalore (IN); Bhaskar Krishnamachari, Los Angeles, CA (US)

(21) Appl. No.: 18/638,391

(22) Filed: Apr. 17, 2024

(51) Int. Cl. G06Q 20/40; G06Q 20/38

(52) U.S. Cl. CPC G06Q 20/4016; G06Q 20/389

(57) ABSTRACT

Methods, systems, and devices for iterative graph embedding of a blockchain network are described. A blockchain embedding service generates, using a graph representation of a blockchain network and a node embedding model, a first set of node embeddings for a first set of blockchain addresses using transaction data for the first set of blockchain addresses. The platform generates, using the graph representation, a second set of node embeddings for a second set of blockchain addresses associated with new transaction data. Generating the second set of node embeddings includes executing, for each node corresponding to blockchain address of the second set of blockchain addresses, a random walk across a set of nodes starting with the node using the transaction data for the set of nodes, inputting data resulting from the random walk into the node embedding model, and computing a risk score for each of the second set of blockchain addresses.

### FIELD OF TECHNOLOGY

The present disclosure relates generally to data management, including techniques for iterative graph embedding of a blockchain network.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports iterative graph embedding of a blockchain network in accordance with aspects of the present disclosure.

FIG. 2 shows an example of a process flow that supports iterative graph embedding of a blockchain network in accordance with aspects of the present disclosure.

FIG. 3 shows an example of a process flow that supports iterative graph embedding of a blockchain network in accordance with aspects of the present disclosure.

FIG. 4 shows an example of a process flow that supports iterative graph embedding of a blockchain network in accordance with aspects of the present disclosure.

FIG. 5 shows a block diagram of an apparatus that supports iterative graph embedding of a blockchain network in accordance with aspects of the present disclosure.

FIG. 6 shows a block diagram of an iterative graph embedding application that supports iterative graph embedding of a blockchain network in accordance with aspects of the present disclosure.

FIG. 7 shows a diagram of a system including a device that supports iterative graph embedding of a blockchain network in accordance with aspects of the present disclosure.

FIGS. 8 and 9 show flowcharts illustrating methods that support iterative graph embedding of a blockchain network in accordance with aspects of the present disclosure.

### DETAILED DESCRIPTION

The use of cryptocurrency in transactions in various industries has increased, and in some cases, the cryptocurrency transactions may be fraudulent, nefarious, criminal, or the like. For example, as blockchains are pseudonymous and identities may not be associated with blockchain addresses, identifying suspicious transactions may be difficult. Moreover, as cryptocurrency sees increased adoption by individuals, countries, and industries, the quantity of addresses and transactions may increase, making identifying suspicious transactions even more difficult. Moreover, some services may implement modeling patterns to identify fraudulent transactions on financial transaction networks, including blockchain networks. For example, the modeling of patterns associated with fraudulent transactions may be based on transaction timestamps, a threshold quantity, linkage to known blockchain addresses, or other financial transaction data. However, such modeling to identify fraudulent transactions may be difficult and inefficient to scale to ever increasing sizes of blockchain networks and the increased amount of transactions. Moreover, the modeling may be further limited to a static pattern of financial transactions, and thus, may be difficult to apply to the dynamic nature of cryptocurrency transactions.

Techniques described herein address these difficulties by supporting generating risk scores for blockchain addresses and the risk scores may be indicative of respective likelihood of fraudulent activity for blockchain addresses. The technique involves a soft binary classification model with outputs corresponding to the risk score. For training and evaluation of the model, a data set including blockchain addresses known to have engaged in malicious behavior may be used in addition to benign addresses. The model may use a behavioral-based feature and a graph-based feature. For the behavioral-based features, the model may identify transactional behavior patterns of an address based on transaction quantity and timestamp. For the graph-based feature, the model may use a vector representation algorithm (e.g., node2vec algorithm) to generate vector embeddings. The vector representation may capture the topology of the cryptocurrency transaction graph, where blockchain addresses are nodes and directed edges correspond to transactions between the addresses. The dynamic node2vec approach described herein may be computationally scalable as the quantity of blockchain addresses increase, as well as capable of handling dynamic transaction graphs in an incremental manner for risk score predictions. For example, the transaction graph may be iteratively recomputed for new data since the previous computation using a distributed task based approach. In this manner, processing power and time may be reduced with respect to recomputing the transaction graph for the entire set of data (e.g., including the data used in for the previously-generated graph and the new data).

For example, a service that has access to data associated with the blockchain network may generate, using a graph representation of the blockchain network and a node embedding model, a first set of node embeddings for a first multiple blockchain addresses of the blockchain network using transaction data associated with transactions occurring on the blockchain network by the first multiple blockchain addresses. The service may generate, using the graph representation of the blockchain network, a second set of node embeddings for a second multiple blockchain addresses that are associated with new transaction data since generation of the first set of node embeddings. Generating the second set of node embeddings may include executing, for each node corresponding to a blockchain address of the second multiple blockchain addresses, a random walk across a set of nodes starting with the node using the transaction data for the set of nodes. Generating the second set of node embeddings may include inputting data resulting from the random walk for each node of the second multiple blockchain addresses into the node embedding model, the inputting resulting in the node embedding model generating the second set of node embeddings. Generating the second set of node embeddings may also include computing, using at least the second set of node embeddings, a risk score for each blockchain address of the second multiple blockchain addresses. These and other techniques are described in further detail with respect to the figures.

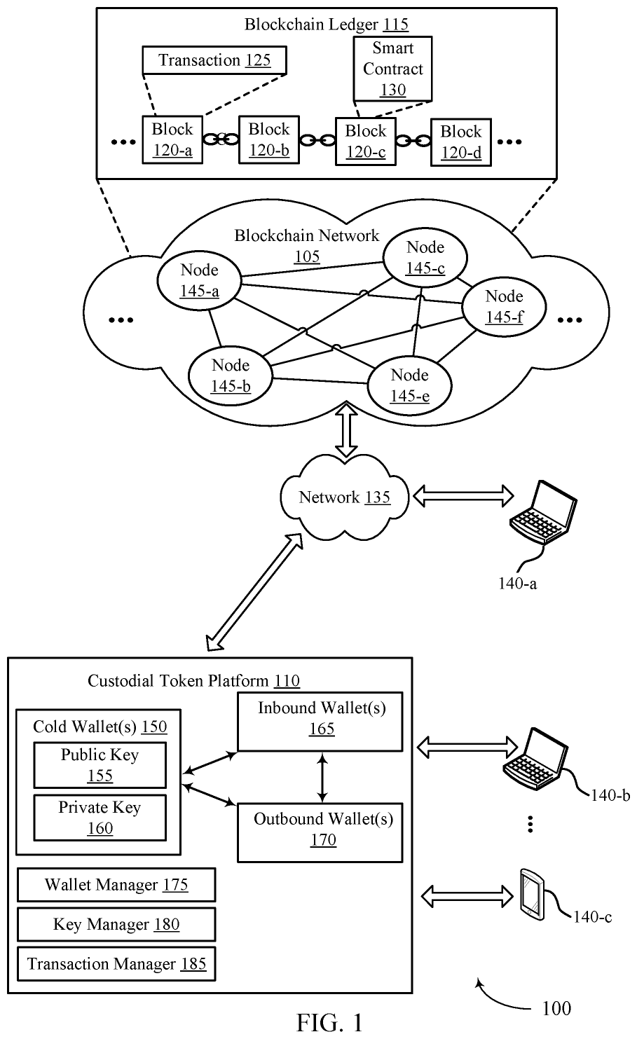

FIG. 1 illustrates an example of a computing environment 100 that supports iterative graph embedding of a blockchain network in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

Additionally, users may access various applications and marketplaces to buy, sell, create, trade, and otherwise transact with blockchain addresses. In some cases, users may engage in certain activity, such as fraudulent or malicious activity. As the use of cryptocurrency increases, and thus, blockchain addresses increase, efficiently generating risk scores for blockchain addresses may be beneficial to efficiently reduce risks associated with blockchain transactions. Some risk assessment techniques may be implemented, such as modeling the patterns associated with fraudulent transactions based on features derived from known transaction timestamps and quantity. However, such modeling may not efficiently provide risk assessments for the exponentially increasing quantity of blockchain addresses used in blockchain transactions and the dynamic transaction data associated with the blockchain transactions.

As discussed herein, the custodial token platform 110 may implement a service or a standalone service may support a scalable technique for predicting the risk scores for blockchain addresses. The technique may involve machine learning and graph analysis to identify patterns and relationships within the blockchain network 105 that may indicate fraudulent activity. Specifically, the custodial token platform 110 may use a node2vec algorithm to generate embeddings for each node in the blockchain network 105 to provide a graphical representation of a blockchain network 105, and behavioral features based on quantity of transactions, transaction amounts, time of transactions, and other behavior-related features, to facilitate accurate models for fraud detection or prediction. The graphical representation may be updated incrementally, such as based on new data on the blockchain network 105 (e.g., new data above a threshold quantity of new data), or periodically (e.g., after a threshold time). In particular, the graphical representation may be updated based on the new data rather than recomputing the graphical representation for the entire data set, which may result in reduced computing overhead (e.g., processor and memory overhead) relative to other risk evaluation techniques. That is, because the techniques described herein support avoiding recomputing risk scores for an entire blockchain network, the computing overhead for risk score computation is reduced.

For example, the custodial token platform 110 may generate, using a graph representation of the blockchain network 105 and a node embedding model, a first set of node embeddings for a first multiple blockchain addresses of the blockchain network 105 using transaction data associated with transactions occurring on the blockchain network 105 by the first multiple blockchain addresses. The custodial token platform 110 may generate, using the graph representation of the blockchain network 105, a second set of node embeddings for a second multiple blockchain addresses that are associated with new transaction data since generation of the first set of node embeddings. Generating the second set of node embeddings may include executing, for each node corresponding to a blockchain address of the second multiple blockchain addresses, a random walk across a set of nodes starting with the node using the transaction data for the set of nodes. Generating the second set of node embeddings may also include inputting data resulting from the random walk for each node of the second multiple blockchain addresses into the node embedding model, the inputting resulting in the node embedding model generating the second set of node embeddings. The custodial token platform may compute, using at least the second set of node embeddings, a risk score for each blockchain address of the second multiple blockchain addresses. In this manner, the custodial token platform 110 may efficiently recompute the graphical representation as new data is received and as additional blockchain addresses are involved in the blockchain transactions (e.g., dynamic transaction graphs with new nodes over time). Processing power and time may be reduced with respect to recomputing the transaction graph for the entire site of data (e.g., including the data used in for the previously-generated graph and the new data) to efficiently provide a risk assessment of the blockchain addresses.

It should be understood that the graph/node embedding techniques described herein may be applicable to support other types of metric generations other than risk scores for blockchain addresses. That is, the incremental embedding techniques described herein may support risk score determination in addition to other metrics.

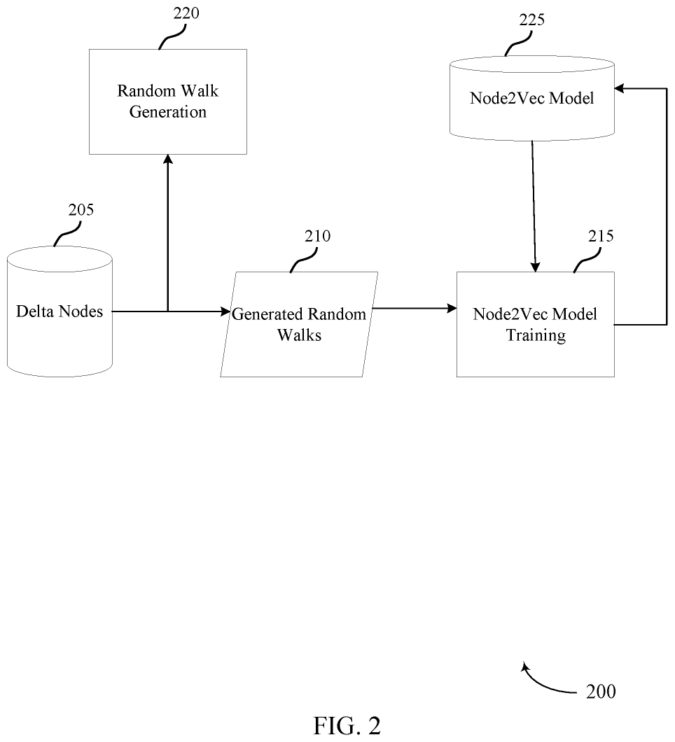

FIG. 2 shows an example of a process flow 200 that supports iterative graph embedding of a blockchain network in accordance with aspects of the present disclosure. More specifically, FIG. 2 illustrates examples operations for incremental training of the Node2Vec embedding model. The process flow 200 may include a chain of components, such as delta nodes 205, generated random walks 210, Node2Vec model training 215, random walk generation 220, and a Node2Vec model 225.

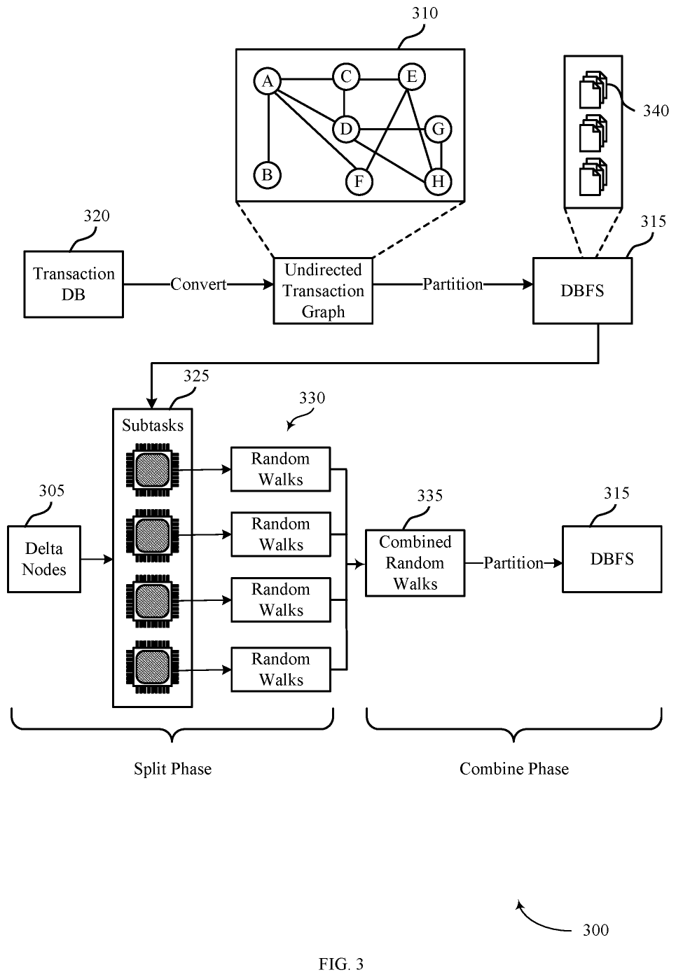

A service (e.g., implemented custodial token platform 110 of FIG. 1) may perform initial training of the Node2Vec model and then incrementally add recently transacted blockchain addresses. In the process flow 200, the delta nodes 205 (e.g., initial nodes used for training) may correspond to blockchain addresses performing blockchain transactions and may be associated with a timestamp, t, as transaction data of the blockchain transactions associated with the blockchain addresses. Using these delta nodes 205, the service may perform the random walks for each of the nodes for random walk generation 220, as discussed with respect to FIG. 3. The delta nodes 205 may be organized or grouped based on tasks and the random walks may be performed on the groups of the delta nodes 205. For example, 20 million delta nodes 205 may be divided into 5 million delta nodes 205 based on a common task and the random walks may be simultaneously performed (e.g., random walk generation 220) for each of the sets of 5 million delta nodes, as discussed with respect to FIG. 3.

After performing the random walks, the generated random walks 210 may be used in the Node2Vec model training 215. The Node2Vec model 225 may be stored at an initial time, t−1, which may be used for training. The Node2Vec model training 215 may be updated and saved periodically at subsequent times, t, since the initial training (e.g., after incremental updating with new data for better results).

In some examples, the training may be based on different parameters (e.g., hyperparameters) of Node2Vec, such as a quantity of walks to perform from each node (r) (e.g., impacting the neighborhood around a node), length of walks (l) or the number of nodes to visit in each random walk (e.g., impacting the length of the node sequences generated during the random walks), return parameter (p) or the likelihood of immediately revisiting the previous node in the random walk, and an in-out parameter (q) or the likelihood of moving away from the previous node in the random walk (e.g., impacting nodes to differentiate between inward and outward nodes). In some examples, if q>1 the random walk may be biased towards nodes close to the starting node. Parameters p. and q may control how quickly the walks explore and leave the neighborhood of a starting node. In some examples, the training may involve a trained random forest classifier with a dynamic configuration and the node2vec embeddings may be an input feature to the model.

Parameters p. and q may control how fast the walks explore and leave the neighborhood of starting node u. It allows the walk generation process to interpolate between Breadth-First Search (BFS) & Depth-First Search (DFS). Based on the evaluation performed on different hyperparameters, keeping p. and q both as 1, and number of walks and length of walks as 10 results in adequate or optimal results. The parameters p. and q influence the exploration dynamics of walks generated by the node2vec algorithm, and these parameters determine the speed at which walks explore and depart from the initial node, providing a flexible mechanism to interpolate between BFS and DFS strategies. Through a comprehensive evaluation involving various hyperparameter settings, setting both p. and q to 1, along with configuring the number of walks and the length of walks to 10, enhances the performance of the walk generation process.

FIG. 3 shows an example of a process flow 300 that supports iterative graph embedding of a blockchain network in accordance with aspects of the present disclosure. More specifically, FIG. 3 illustrates examples operations for generating random walks a distributed processing approach (e.g., MapReduce). The process flow 300 may include a delta nodes 305 (e.g., delta nodes 205 of FIG. 2), a undirected transaction graph 310, a distributed file system 315, a transaction database 320, subtasks 325, random walks 330, and combined random walks 335. The process flow 300 illustrates example operations for iteratively generating embeddings for nodes (e.g., blockchain addresses) of a blockchain network. For example, a service (e.g., implemented by a custodial token platform 110 of FIG. 1) may implement aspects of the process flow 300 to generate node embeddings to compute risk scores for blockchain addresses. Aspects of the process flow are described with respect to using the distributed file system 315, but it should be understood that the techniques described herein may be implemented with respect to other types of file systems (e.g., centralized file system), data storage systems, etc.

As described herein, a graph learning algorithm may be implemented to support incremental training of a blockchain transaction graph, and due to the evolving nature of the blockchain transaction graph, each training iteration may take incremental graph information as input and embeddings may be updated for addresses in changed regions since last training. Dynamic Node2Vec may support such characteristics, but corresponding libraries may load the entire graph into memory which may limit the size of the graph due to memory constraints. Thus, the MapReduce approach described herein may be used to compute random walks in a scalable manner.

The process flow 300 may involve, for each timestamp, the service generating or obtaining a graph representation of nodes based on an interaction count (e.g., total quantity of interactions for each of the nodes). For example, in the process flow 300, the service may use transaction data from the transaction database 320 associated with blockchain addresses (e.g., where the transaction database includes address and transaction data for the blockchain network), and this data may be converted into an undirected transaction graph 310. The undirected transaction graph 310 may be stored as node pairs on the distributed file system 315 partitioned by source node (e.g., delta nodes). The neighboring nodes to a source node may be sorted based on interaction count to generate a node neighbor list (e.g., node neighbor list 340), and the top neighbor K nearest neighbor nodes may be selected from the neighbor node list. In particular, for each timestamp, the undirected transaction graph 310 may be stored as node pairs on the distributed file system 315 partitioned by source node. For each source node, a quantity of neighbors may be sorted based on the interaction count, and the top K (e.g., K=200) nearest neighbors may be selected. The data (e.g., transaction data) associated with the selected nearest neighbors data may be used for random walk generation as described herein.

More particularly, a split-apply-combine procedure may be applied for random walk generation. Thus, as part of a split phase, each delta node 305 (e.g., nodes) may be assigned to one of several subtasks 325, and each subtask iterates through the assigned delta nodes to generate random walks. Thus, for each assigned delta node, the subtask loads a file that contains the neighboring nodes (associated with the delta node) from the distributed file system that stores the graph data. The subtasks may then conduct a randomized selection process according to the node2Vec hyperparameters to generate a random walk 330 for the delta node. The random walks 330 may then be combined (e.g., in a combine phase) into the combined random walks 335 based on the source nodes and saved to the distributed file system 315. This data may then be used to generate risk scores for at least the updated nodes of the node graph.

Using the described distributed approach for random walks 330, random walks 330 for large graphs may be generated in a time-efficient manner on blockchain transaction graphs. After initial training, an incremental training may be performed (e.g., daily) where random walks 330 are generated on the delta nodes 305 that are inputted to the model for retraining. For nodes that are involved in random walks 330 of delta nodes 305 (e.g., delta walks), their embedding in training may be initialized with values from previous iterations and updated through retraining. For nodes that are not involved in the delta walks, embedding may not be updated in retraining. As such, the entire graph is not necessarily loaded in memory for retraining or random walk generation, which supports a reduction in computing resource overhead for graph embedding a blockchain network.

In some examples, the behavioral features used to compute the risk scores for the blockchain addresses may be dependent on the type of token transacted. For example, in the case of the Ethereum blockchain network, two sets of behavioral features may be used: one based on Ethereum transactions of a particular address and the other based on ERC-20 token based transactions performed by an address. These techniques support acquiring valuable insights from both types of transactions and capturing both allows the model to utilize the spending patterns linked to different Ethereum-based tokens as a potential indicator to assess address risk score. The risk scoring model may employ three sets of features which can capture the transactional pattern of an address. The first set of features may be based on Ethereum transactions of an address, and the second set of features may be based on ERC-20 transactions for a particular address. Apart from these behavioral features a graph based feature (e.g., node2vec embedding) may be used, and the graph based feature captures topology of the graph. In order to classify an address into a specific risk class, a random forest classifier model is used, and the three sets of features are combined. The resulting vector is used as input to the classifier model. This approach supports leveraging the combined power of Node2Vec embeddings and transactional data for accurate risk classification of addresses.

Further, the model may be initialized on a limited first set of addresses (e.g., 30 million), and these addresses may be used to generate the node2vec embeddings, which results in core node2vec embeddings. This limited set of addresses may be from addresses from the Ethereum blockchain which have transacted with any addresses in a training set, and these addresses are randomly sampled to generate the limited first set of addresses from a broader set of addresses. After the core set of embeddings are generated, the random walk technique described herein is used to generate embeddings for remaining addresses. After embeddings for the blockchain network are generated, the random walk technique may be implemented periodically (e.g., on a scheduled basis) to generate embeddings for delta nodes identified based on the new transaction data.

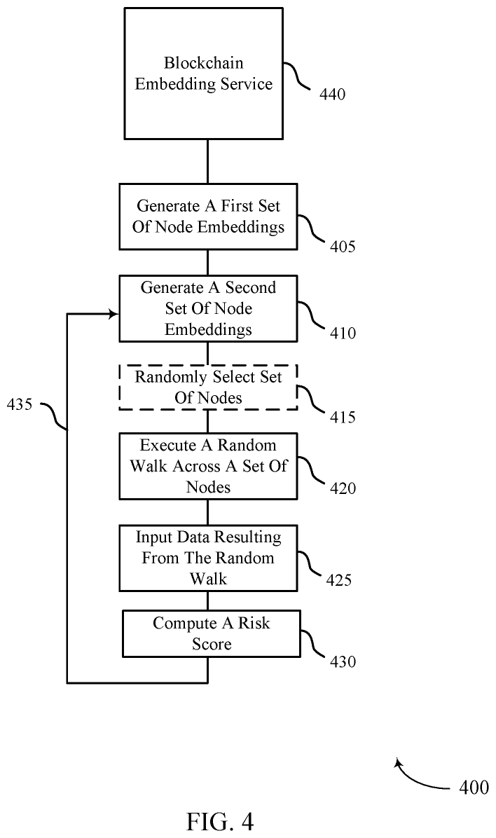

FIG. 4 shows an example of a process flow 400 that supports iterative graph embedding of a blockchain network in accordance with aspects of the present disclosure. The process flow 400 includes a blockchain embedding service 440, which may be an example of service as described with respect to FIGS. 1 through 3. In some examples, the blockchain embedding service 440 may be supported by a custodial token platform 110 of FIG. 1. In the following description of the process flow 400, the operations performed by the custodial token platform 110-a may be transmitted in a different order than the example order shown, or the operations performed may be performed in different orders or at different times. Some operations may also be omitted from the process flow 400, and other operations may be added to the process flow 400.

At 405, the blockchain embedding service 440 may generate, using a graph representation of a blockchain network (e.g., an undirected transaction graph) and a node embedding model (e.g., node2vec), a first set of node embeddings for a first set of blockchain addresses of the blockchain network using transaction data associated with transactions occurring on the blockchain network by the first set of blockchain addresses. The transaction data for the first set of blockchain addresses may be associated with transactions occurring on the blockchain network during a first time period. At 410, the blockchain embedding service 440 may generate, using the graph representation of the blockchain network, a second set of node embeddings for a second set of blockchain addresses that are associated with new transaction data since generation of the first set of node embeddings. For example, the blockchain embedding service 440 may store the graph representation as node pairs on a distributed file system partition by source node (e.g., delta node). The blockchain embedding service 440 may then sort neighbors for each source node based on transaction count with the source node and select the top K nearest neighbors for random walks. In some examples, at 415, the blockchain embedding service 440 may randomly select, starting with the source/delta node, the set of nodes that are neighboring nodes based on one or more parameters (e.g., node2vec hyperparameters).

At 420, the blockchain embedding service 440 may generate the second set of node embeddings. Generating the second set of node embeddings may include executing, for each node corresponding to a blockchain address of the second set of blockchain addresses, a random walk across a set of nodes starting with the node using the transaction data for the set of nodes. The new transaction data for the second set of blockchain addresses may be associated with transactions occurring on the blockchain network during a second time period subsequent to the first time period. At 425, generating the second set of node embeddings may further include inputting data resulting from the random walk for each node of the second set of blockchain addresses into the node embedding model. The inputting may result in the node embedding model generating the second set of node embeddings. At 430, the blockchain embedding service may compute, using at least the second set of node embeddings, a risk score for each blockchain address of the second set of blockchain addresses.

In some examples, executing the random walk for a node corresponding to the blockchain address of the second set of blockchain addresses may include selecting from a list of neighboring nodes for the node corresponding to the blockchain address. In some examples, the list of neighboring nodes may be sorted based on an interaction count for each neighbor node to the node corresponding to the blockchain address of the second plurality of blockchain addresses, and the interaction count is based on the new transaction data. The list of neighboring nodes may be loaded from a distributed file system and the data resulting from the random walk for the node is stored to the distributed file system.

In some examples, the blockchain embedding service 440 may update the first set of node embeddings based at least in part on the data resulting from each random walk that impacts any node embedding of the first set of node embeddings. To generate the second set of node embeddings, the blockchain embedding service 440 may allocate each node of the second set of blockchain addresses to a respective subtask. Each subtask may conduct the random walk for the node and combine the data resulting from each random walk for input into the node embedding model. To compute the risk score, the blockchain embedding service 440 may compute the risk score for each blockchain address using a random forest classifier and set of behavioral features.

After computing the risk score, at 435, the blockchain embedding service 440 may iterate the generation of the second set of node embeddings. That is, the blockchain embedding service 440 may identify nodes (e.g., delta nodes) with new transaction data since computing the last risk scores and generate new embeddings based on new random walks for the delta nodes. The blockchain embedding service 440 may then generate new risk scores based on the new embeddings.

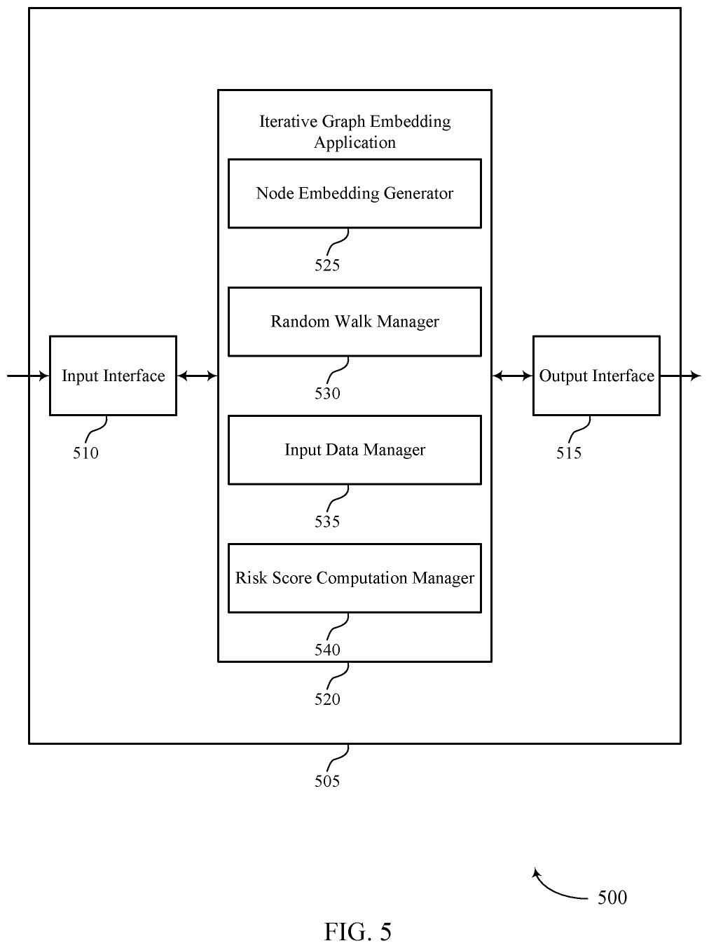

FIG. 5 shows a block diagram 500 of a device 505 that supports iterative graph embedding of a blockchain network in accordance with aspects of the present disclosure. The device 505 may include an input interface 510, an output interface 515, and an iterative graph embedding application 520. The device 505, or one or more components of the device 505 (e.g., the input interface 510, the output interface 515, the iterative graph embedding application 520), may include at least one processor, which may be coupled with at least one memory, to support the described techniques. Each of these components may communicate, directly or indirectly, with one another (e.g., via one or more buses, communications links, communications interfaces, or any combination thereof).

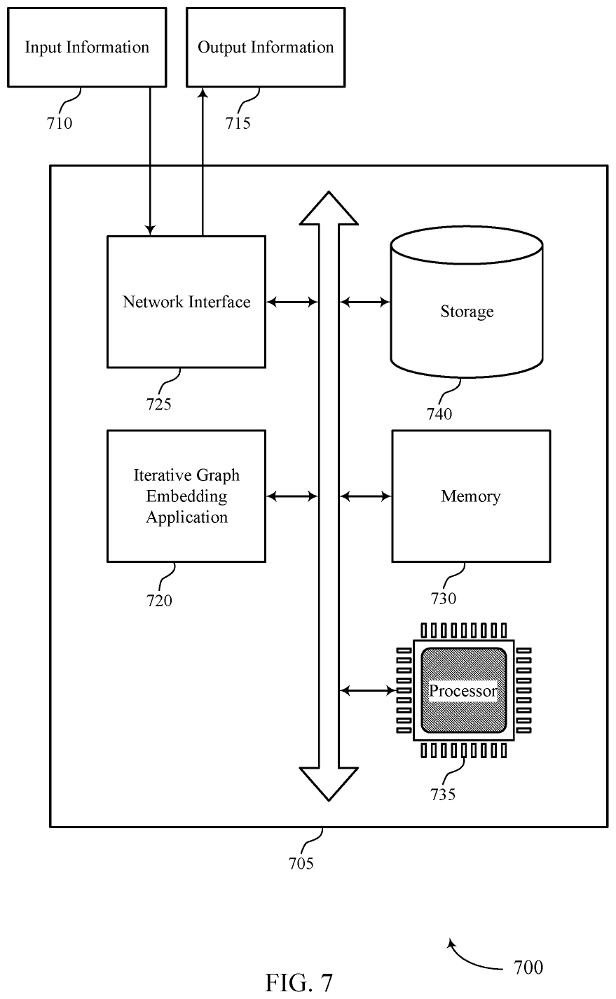

The input interface 510 may manage input signaling for the device 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the device 505 for processing. For example, the input interface 510 may transmit such corresponding signaling to the iterative graph embedding application 520 to support iterative graph embedding of a blockchain network. In some cases, the input interface 510 may be a component of a network interface 725 as described with reference to FIG. 7.

The output interface 515 may manage output signaling for the device 505. For example, the output interface 515 may receive signaling from other components of the device 505, such as the iterative graph embedding application 520, and may transmit such output signaling corresponding to (e.g., representative of or otherwise based on) such signaling to other systems or devices. In some cases, the output interface 515 may be a component of a network interface 725 as described with reference to FIG. 7.

For example, the iterative graph embedding application 520 may include a node embedding generator 525, a random walk manager 530, an input data manager 535, a risk score computation manager 540, or any combination thereof. In some examples, the iterative graph embedding application 520, or various components thereof, may be configured to perform various operations (e.g., receiving, monitoring, transmitting) using or otherwise in cooperation with the input interface 510, the output interface 515, or both. For example, the iterative graph embedding application 520 may receive information from the input interface 510, send information to the output interface 515, or be integrated in combination with the input interface 510, the output interface 515, or both to receive information, transmit information, or perform various other operations as described herein.

The iterative graph embedding application 520 may support calculating risk scores for blockchain addresses in accordance with examples as disclosed herein. The node embedding generator 525 may be configured as or otherwise support a means for generating, using a graph representation of a blockchain network and a node embedding model, a first set of node embeddings for a first plurality of blockchain addresses of the blockchain network using transaction data associated with transactions occurring on the blockchain network by the first plurality of blockchain addresses. The node embedding generator 525 may be configured as or otherwise support a means for generating, using the graph representation of the blockchain network, a second set of node embeddings for a second plurality of blockchain addresses that are associated with new transaction data since generation of the first set of node embeddings, wherein generating the second set of node embeddings comprises. The random walk manager 530 may be configured as or otherwise support a means for executing, for each node corresponding to a blockchain address of the second plurality of blockchain addresses, a random walk across a set of nodes starting with the node using the transaction data for the set of nodes. The input data manager 535 may be configured as or otherwise support a means for inputting data resulting from the random walk for each node of the second plurality of blockchain addresses into the node embedding model, the inputting resulting in the node embedding model generating the second set of node embeddings. The risk score computation manager 540 may be configured as or otherwise support a means for computing, using at least the second set of node embeddings, a risk score for each blockchain address of the second plurality of blockchain addresses.

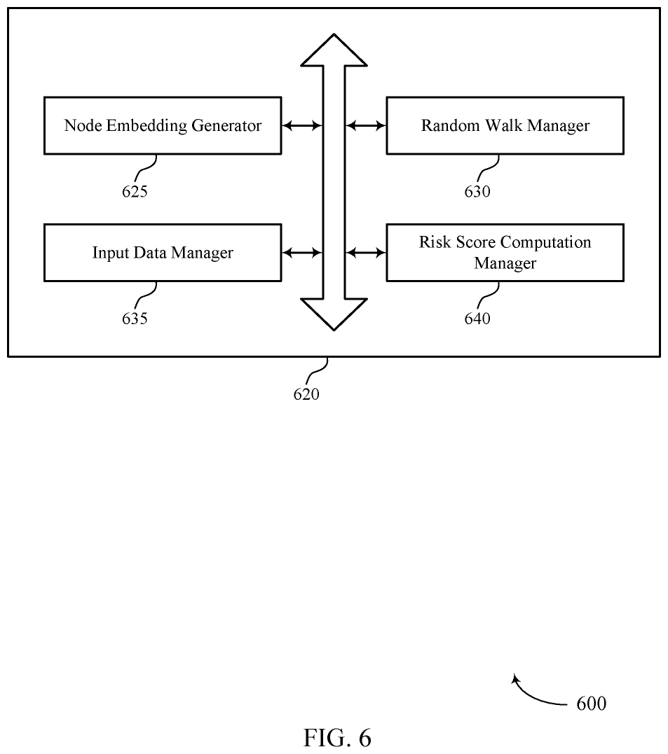

FIG. 6 shows a block diagram 600 of a iterative graph embedding application 620 that supports iterative graph embedding of a blockchain network in accordance with aspects of the present disclosure. The iterative graph embedding application 620 may be an example of aspects of an iterative graph embedding application or an iterative graph embedding application 520, or both, as described herein. The iterative graph embedding application 620, or various components thereof, may be an example of means for performing various aspects of iterative graph embedding of a blockchain network as described herein. For example, the iterative graph embedding application 620 may include a node embedding generator 625, a random walk manager 630, an input data manager 635, a risk score computation manager 640, or any combination thereof. Each of these components may communicate, directly or indirectly, with one another (e.g., via one or more buses, communications links, communications interfaces, or any combination thereof).

The iterative graph embedding application 620 may support calculating risk scores for blockchain addresses in accordance with examples as disclosed herein. The node embedding generator 625 may be configured as or otherwise support a means for generating, using a graph representation of a blockchain network and a node embedding model, a first set of node embeddings for a first plurality of blockchain addresses of the blockchain network using transaction data associated with transactions occurring on the blockchain network by the first plurality of blockchain addresses. In some examples, the node embedding generator 625 may be configured as or otherwise support a means for generating, using the graph representation of the blockchain network, a second set of node embeddings for a second plurality of blockchain addresses that are associated with new transaction data since generation of the first set of node embeddings, wherein generating the second set of node embeddings comprises. The random walk manager 630 may be configured as or otherwise support a means for executing, for each node corresponding to a blockchain address of the second plurality of blockchain addresses, a random walk across a set of nodes starting with the node using the transaction data for the set of nodes. The input data manager 635 may be configured as or otherwise support a means for inputting data resulting from the random walk for each node of the second plurality of blockchain addresses into the node embedding model, the inputting resulting in the node embedding model generating the second set of node embeddings. The risk score computation manager 640 may be configured as or otherwise support a means for computing, using at least the second set of node embeddings, a risk score for each blockchain address of the second plurality of blockchain addresses.

In some examples, to support executing the random walk for a node corresponding to the blockchain address of the second plurality of blockchain addresses, the random walk manager 630 may be configured as or otherwise support a means for randomly selecting, starting with the node, the set of nodes that are neighboring nodes based on one or more parameters.

In some examples, to support executing the random walk for the node corresponding to the blockchain address of the second plurality of blockchain addresses, the random walk manager 630 may be configured as or otherwise support a means for selecting from a list of neighboring nodes for the node corresponding to the blockchain address.

In some examples, the list of neighboring nodes is sorted based on an interaction count for each neighbor node to the node corresponding to the blockchain address of the second plurality of blockchain addresses. In some examples, the interaction count is based on the new transaction data.

In some examples, the list of neighboring nodes is loaded from a distributed file system and. In some examples, the data resulting from the random walk for the node is stored to the distributed file system.

In some examples, the node embedding generator 625 may be configured as or otherwise support a means for updating the first set of node embeddings based at least in part on the data resulting from each random walk that impacts any node embedding of the first set of node embeddings.

In some examples, to support generating the second set of node embeddings, the node embedding generator 625 may be configured as or otherwise support a means for allocating each node of the second plurality of blockchain addresses to a respective subtask, wherein each subtask conducts the random walk for the node. In some examples, to support generating the second set of node embeddings, the node embedding generator 625 may be configured as or otherwise support a means for combining the data resulting from each random walk for input into the node embedding model.

In some examples, the transaction data for the first plurality of blockchain addresses is associated with transactions occurring on the blockchain network during a first time period. In some examples, the new transaction data for the second plurality of blockchain addresses is associated with transactions occurring on the blockchain network during a second time period subsequent to the first time period.

In some examples, to support computing the risk score, the risk score computation manager 640 may be configured as or otherwise support a means for computing the risk score for each blockchain address using a random forest classifier and set of behavioral features.

FIG. 7 shows a diagram of a system 700 including a system 705 that supports iterative graph embedding of a blockchain network in accordance with aspects of the present disclosure. The system 705 may be an example of or include components of a device 505 as described herein. The system 705 may include components for bi-directional voice and data communications including components for transmitting and receiving communications, such as a iterative graph embedding application 720 (e.g., a blockchain node embedding service), an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting iterative graph embedding of a blockchain network. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting iterative graph embedding of a blockchain network). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

The iterative graph embedding application 720 may support calculating risk scores for blockchain addresses in accordance with examples as disclosed herein. For example, the iterative graph embedding application 720 may be configured as or otherwise support a means for generating, using a graph representation of a blockchain network and a node embedding model, a first set of node embeddings for a first plurality of blockchain addresses of the blockchain network using transaction data associated with transactions occurring on the blockchain network by the first plurality of blockchain addresses. The iterative graph embedding application 720 may be configured as or otherwise support a means for generating, using the graph representation of the blockchain network, a second set of node embeddings for a second plurality of blockchain addresses that are associated with new transaction data since generation of the first set of node embeddings, wherein generating the second set of node embeddings comprises. The iterative graph embedding application 720 may be configured as or otherwise support a means for executing, for each node corresponding to a blockchain address of the second plurality of blockchain addresses, a random walk across a set of nodes starting with the node using the transaction data for the set of nodes. The iterative graph embedding application 720 may be configured as or otherwise support a means for inputting data resulting from the random walk for each node of the second plurality of blockchain addresses into the node embedding model, the inputting resulting in the node embedding model generating the second set of node embeddings. The iterative graph embedding application 720 may be configured as or otherwise support a means for computing, using at least the second set of node embeddings, a risk score for each blockchain address of the second plurality of blockchain addresses.

By including or configuring the iterative graph embedding application 720 in accordance with examples as described herein, the system 705 may support techniques for efficiently providing a risk assessment of blockchain addresses for an increasing quantity of blockchain addresses and for dynamic transaction data associated with the blockchain addresses.

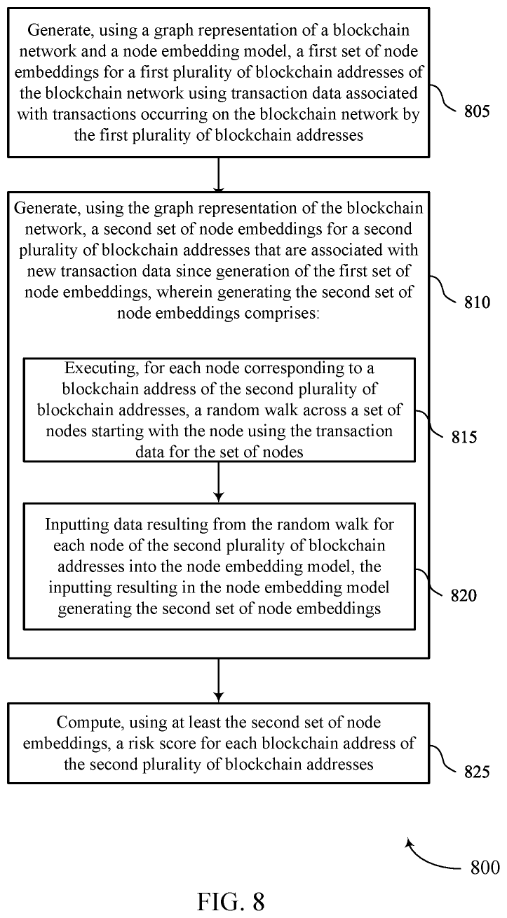

FIG. 8 shows a flowchart illustrating a method 800 that supports iterative graph embedding of a blockchain network in accordance with aspects of the present disclosure. The operations of the method 800 may be implemented by a custodial token platform or its components as described herein. For example, the operations of the method 800 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include generating, using a graph representation of a blockchain network and a node embedding model, a first set of node embeddings for a first plurality of blockchain addresses of the blockchain network using transaction data associated with transactions occurring on the blockchain network by the first plurality of blockchain addresses. The operations of 805 may be performed in accordance with examples as disclosed herein. In some examples, aspects of the operations of 805 may be performed by a node embedding generator 625 as described with reference to FIG. 6.

At 810, the method may include generating, using the graph representation of the blockchain network, a second set of node embeddings for a second plurality of blockchain addresses that are associated with new transaction data since generation of the first set of node embeddings. The operations of 810 may be performed in accordance with examples as disclosed herein. In some examples, aspects of the operations of 810 may be performed by a node embedding generator 625 as described with reference to FIG. 6.

At 815, to generate the second set of node embeddings, the method may include executing, for each node corresponding to a blockchain address of the second plurality of blockchain addresses, a random walk across a set of nodes starting with the node using the transaction data for the set of nodes. The operations of 815 may be performed in accordance with examples as disclosed herein. In some examples, aspects of the operations of 815 may be performed by a random walk manager 630 as described with reference to FIG. 6.

At 820, to generate the second set of node embeddings, the method may include inputting data resulting from the random walk for each node of the second plurality of blockchain addresses into the node embedding model, the inputting resulting in the node embedding model generating the second set of node embeddings. The operations of 820 may be performed in accordance with examples as disclosed herein. In some examples, aspects of the operations of 820 may be performed by an input data manager 635 as described with reference to FIG. 6.

At 825, the method may include computing, using at least the second set of node embeddings, a risk score for each blockchain address of the second plurality of blockchain addresses. The operations of 825 may be performed in accordance with examples as disclosed herein. In some examples, aspects of the operations of 825 may be performed by a risk score computation manager 640 as described with reference to FIG. 6.

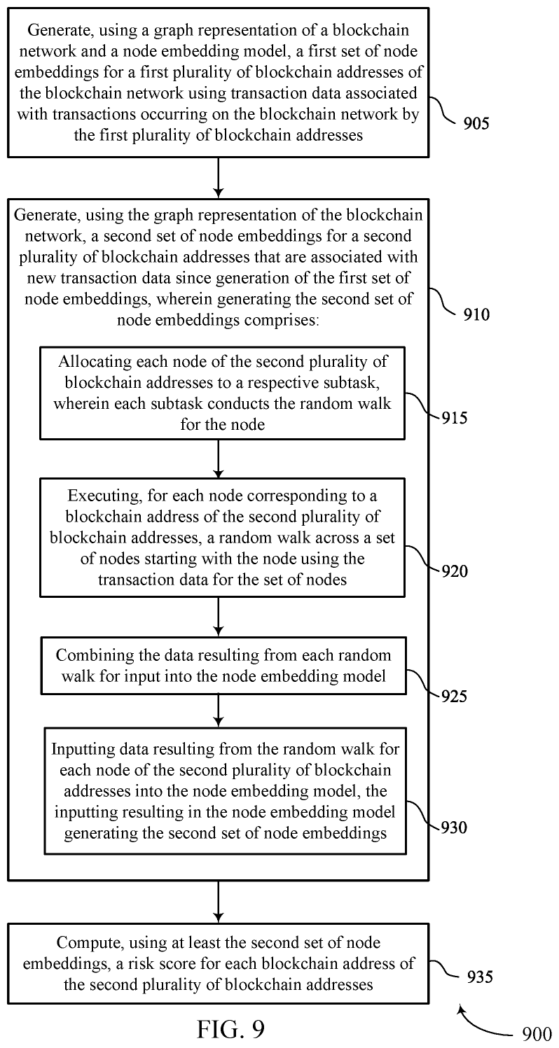

FIG. 9 shows a flowchart illustrating a method 900 that supports iterative graph embedding of a blockchain network in accordance with aspects of the present disclosure. The operations of the method 900 may be implemented by a custodial token platform or its components as described herein. For example, the operations of the method 900 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 905, the method may include generating, using a graph representation of a blockchain network and a node embedding model, a first set of node embeddings for a first plurality of blockchain addresses of the blockchain network using transaction data associated with transactions occurring on the blockchain network by the first plurality of blockchain addresses. The operations of 905 may be performed in accordance with examples as disclosed herein. In some examples, aspects of the operations of 905 may be performed by a node embedding generator 625 as described with reference to FIG. 6.

At 910, the method may include generating, using the graph representation of the blockchain network, a second set of node embeddings for a second plurality of blockchain addresses that are associated with new transaction data since generation of the first set of node embeddings, wherein generating the second set of node embeddings comprises. The operations of 910 may be performed in accordance with examples as disclosed herein. In some examples, aspects of the operations of 910 may be performed by a node embedding generator 625 as described with reference to FIG. 6.

At 915, to generate the second set of node embeddings, the method may include allocating each node of the second plurality of blockchain addresses to a respective subtask where each subtask conducts the random walk for the node. The operations of 915 may be performed in accordance with examples as disclosed herein. In some examples, aspects of the operations of 915 may be performed by a random walk manager 630 as described with reference to FIG. 6.

At 920, to generate the second set of node embeddings, the method may include executing, for each node corresponding to a blockchain address of the second plurality of blockchain addresses, a random walk across a set of nodes starting with the node using the transaction data for the set of nodes. The operations of 920 may be performed in accordance with examples as disclosed herein. In some examples, aspects of the operations of 920 may be performed by a node embedding generator 625 as described with reference to FIG. 6.

At 925, to generate the second set of node embeddings, the method may include combining the data resulting from each random walk for input into the node embedding model. The operations of 925 may be performed in accordance with examples as disclosed herein. In some examples, aspects of the operations of 925 may be performed by a node embedding generator 625 as described with reference to FIG. 6.

At 930, to generate the second set of node embeddings, the method may include inputting data resulting from the random walk for each node of the second plurality of blockchain addresses into the node embedding model, the inputting resulting in the node embedding model generating the second set of node embeddings. The operations of 930 may be performed in accordance with examples as disclosed herein. In some examples, aspects of the operations of 930 may be performed by an input data manager 635 as described with reference to FIG. 6.

At 935, the method may include computing, using at least the second set of node embeddings, a risk score for each blockchain address of the second plurality of blockchain addresses. The operations of 935 may be performed in accordance with examples as disclosed herein. In some examples, aspects of the operations of 935 may be performed by a risk score computation manager 640 as described with reference to FIG. 6.

A method for calculating risk scores for blockchain addresses by an apparatus is described. The method may include generating, using a graph representation of a blockchain network and a node embedding model, a first set of node embeddings for a first plurality of blockchain addresses of the blockchain network using transaction data associated with transactions occurring on the blockchain network by the first plurality of blockchain addresses, generating, using the graph representation of the blockchain network, a second set of node embeddings for a second plurality of blockchain addresses that are associated with new transaction data since generation of the first set of node embeddings, wherein generating the second set of node embeddings comprises, executing, for each node corresponding to a blockchain address of the second plurality of blockchain addresses, a random walk across a set of nodes starting with the node using the transaction data for the set of nodes, inputting data resulting from the random walk for each node of the second plurality of blockchain addresses into the node embedding model, the inputting resulting in the node embedding model generating the second set of node embeddings, and computing, using at least the second set of node embeddings, a risk score for each blockchain address of the second plurality of blockchain addresses.

An apparatus for calculating risk scores for blockchain addresses is described. The apparatus may include one or more memories storing processor executable code, and one or more processors coupled with the one or more memories. The one or more processors may individually or collectively be operable to execute the code to cause the apparatus to generate, using a graph representation of a blockchain network and a node embedding model, a first set of node embeddings for a first plurality of blockchain addresses of the blockchain network using transaction data associated with transactions occurring on the blockchain network by the first plurality of blockchain addresses, generate, using the graph representation of the blockchain network, a second set of node embeddings for a second plurality of blockchain addresses that are associated with new transaction data since generation of the first set of node embeddings, wherein generating the second set of node embeddings comprises, execute, for each node corresponding to a blockchain address of the second plurality of blockchain addresses, a random walk across a set of nodes starting with the node using the transaction data for the set of nodes, input data resulting from the random walk for each node of the second plurality of blockchain addresses into the node embedding model, the inputting resulting in the node embedding model generating the second set of node embeddings, and computing, used at least the second set of node embeddings, a risk score for each blockchain address of the second plurality of blockchain addresses.

Another apparatus for calculating risk scores for blockchain addresses is described. The apparatus may include means for generating, using a graph representation of a blockchain network and a node embedding model, a first set of node embeddings for a first plurality of blockchain addresses of the blockchain network using transaction data associated with transactions occurring on the blockchain network by the first plurality of blockchain addresses, means for generating, using the graph representation of the blockchain network, a second set of node embeddings for a second plurality of blockchain addresses that are associated with new transaction data since generation of the first set of node embeddings, wherein generating the second set of node embeddings comprises, means for executing, for each node corresponding to a blockchain address of the second plurality of blockchain addresses, a random walk across a set of nodes starting with the node using the transaction data for the set of nodes, means for inputting data resulting from the random walk for each node of the second plurality of blockchain addresses into the node embedding model, the inputting resulting in the node embedding model generating the second set of node embeddings, and means for computing, using at least the second set of node embeddings, a risk score for each blockchain address of the second plurality of blockchain addresses.

A non-transitory computer-readable medium storing code for calculating risk scores for blockchain addresses is described. The code may include instructions executable by one or more processors to generate, using a graph representation of a blockchain network and a node embedding model, a first set of node embeddings for a first plurality of blockchain addresses of the blockchain network using transaction data associated with transactions occurring on the blockchain network by the first plurality of blockchain addresses, generate, using the graph representation of the blockchain network, a second set of node embeddings for a second plurality of blockchain addresses that are associated with new transaction data since generation of the first set of node embeddings, wherein generating the second set of node embeddings comprises, execute, for each node corresponding to a blockchain address of the second plurality of blockchain addresses, a random walk across a set of nodes starting with the node using the transaction data for the set of nodes, input data resulting from the random walk for each node of the second plurality of blockchain addresses into the node embedding model, the inputting resulting in the node embedding model generating the second set of node embeddings, and computing, used at least the second set of node embeddings, a risk score for each blockchain address of the second plurality of blockchain addresses.

In some examples of the method, apparatus, and non-transitory computer-readable medium described herein, executing the random walk for a node corresponding to the blockchain address of the second plurality of blockchain addresses may include operations, features, means, or instructions for randomly selecting, starting with the node, the set of nodes that may be neighboring nodes based on one or more parameters.

In some examples of the method, apparatus, and non-transitory computer-readable medium described herein, executing the random walk for the node corresponding to the blockchain address of the second plurality of blockchain addresses may include operations, features, means, or instructions for selecting from a list of neighboring nodes for the node corresponding to the blockchain address.

In some examples of the method, apparatus, and non-transitory computer-readable medium described herein, the list of neighboring nodes may be sorted based on an interaction count for each neighbor node to the node corresponding to the blockchain address of the second plurality of blockchain addresses and the interaction count may be based on the new transaction data.

In some examples of the method, apparatus, and non-transitory computer-readable medium described herein, the list of neighboring nodes may be loaded from a distributed file system and the data resulting from the random walk for the node may be stored to the distributed file system.

Some examples of the method, apparatus, and non-transitory computer-readable medium described herein may further include operations, features, means, or instructions for updating the first set of node embeddings based at least in part on the data resulting from each random walk that impacts any node embedding of the first set of node embeddings.

In some examples of the method, apparatus, and non-transitory computer-readable medium described herein, generating the second set of node embeddings may include operations, features, means, or instructions for allocating each node of the second plurality of blockchain addresses to a respective subtask, wherein each subtask conducts the random walk for the node and combining the data resulting from each random walk for input into the node embedding model.

In some examples of the method, apparatus, and non-transitory computer-readable medium described herein, the transaction data for the first plurality of blockchain addresses may be associated with transactions occurring on the blockchain network during a first time period and the new transaction data for the second plurality of blockchain addresses may be associated with transactions occurring on the blockchain network during a second time period subsequent to the first time period.

In some examples of the method, apparatus, and non-transitory computer-readable medium described herein, computing the risk score may include operations, features, means, or instructions for computing the risk score for each blockchain address using a random forest classifier and set of behavioral features.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for calculating risk scores for blockchain addresses, comprising:
generating, using a graph representation of a blockchain network and a node embedding model, a first set of node embeddings for a first plurality of blockchain addresses of the blockchain network using transaction data associated with transactions occurring on the blockchain network by the first plurality of blockchain addresses; and
generating, using the graph representation of the blockchain network, a second set of node embeddings for a second plurality of blockchain addresses that are associated with new transaction data since generation of the first set of node embeddings, wherein generating the second set of node embeddings comprises:
executing, for each node corresponding to a blockchain address of the second plurality of blockchain addresses, a random walk across a set of nodes starting with the node using the transaction data for the set of nodes;
inputting data resulting from the random walk for each node of the second plurality of blockchain addresses into the node embedding model, the inputting resulting in the node embedding model generating the second set of node embeddings; and
computing, using at least the second set of node embeddings, a risk score for each blockchain address of the second plurality of blockchain addresses.

2. The method of claim 1, wherein executing the random walk for a node corresponding to the blockchain address of the second plurality of blockchain addresses comprises:
randomly selecting, starting with the node, the set of nodes that are neighboring nodes based on one or more parameters.

3. The method of claim 1, wherein executing the random walk for the node corresponding to the blockchain address of the second plurality of blockchain addresses comprises:
selecting from a list of neighboring nodes for the node corresponding to the blockchain address.

4. The method of claim 3, wherein:
the list of neighboring nodes is sorted based on an interaction count for each neighbor node to the node corresponding to the blockchain address of the second plurality of blockchain addresses; and
the interaction count is based on the new transaction data.

5. The method of claim 3, wherein:
the list of neighboring nodes is loaded from a distributed file system and the data resulting from the random walk for the node is stored to the distributed file system.

6. The method of claim 3, wherein embeddings for one or more nodes in the list of neighboring nodes are initialized with one or more node embeddings of the first set of node embeddings, the method further comprising:
updating the first set of node embeddings based at least in part on the data resulting from each random walk that impacts any node embedding of the first set of node embeddings.

7. The method of claim 1, wherein generating the second set of node embeddings comprises:
allocating each node of the second plurality of blockchain addresses to a respective subtask, wherein each subtask conducts the random walk for the node; and
combining the data resulting from each random walk for input into the node embedding model.

8. The method of claim 1, wherein:
the transaction data for the first plurality of blockchain addresses is associated with transactions occurring on the blockchain network during a first time period; and
the new transaction data for the second plurality of blockchain addresses is associated with transactions occurring on the blockchain network during a second time period subsequent to the first time period.

9. The method of claim 1, wherein computing the risk score comprises:
computing the risk score for each blockchain address using a random forest classifier and set of behavioral features.

10. An apparatus for calculating risk scores for blockchain addresses, comprising:
one or more memories storing processor-executable code; and
one or more processors coupled with the one or more memories and individually or collectively operable to execute the code to cause the apparatus to:
generate, using a graph representation of a blockchain network and a node embedding model, a first set of node embeddings for a first plurality of blockchain addresses of the blockchain network using transaction data associated with transactions occurring on the blockchain network by the first plurality of blockchain addresses; and
generate, using the graph representation of the blockchain network, a second set of node embeddings for a second plurality of blockchain addresses that are associated with new transaction data since generation of the first set of node embeddings, wherein generating the second set of node embeddings comprises:
executing, for each node corresponding to a blockchain address of the second plurality of blockchain addresses, a random walk across a set of nodes starting with the node using the transaction data for the set of nodes;
inputting data resulting from the random walk for each node of the second plurality of blockchain addresses into the node embedding model, the inputting resulting in the node embedding model generating the second set of node embeddings; and
computing, using at least the second set of node embeddings, a risk score for each blockchain address of the second plurality of blockchain addresses.

11. The apparatus of claim 10, wherein, to execute the random walk for a node corresponding to the blockchain address of the second plurality of blockchain addresses, the one or more processors are individually or collectively operable to execute the code to cause the apparatus to:
randomly select, starting with the node, the set of nodes that are neighboring nodes based on one or more parameters.

12. The apparatus of claim 10, wherein, to execute the random walk for the node corresponding to the blockchain address of the second plurality of blockchain addresses, the one or more processors are individually or collectively operable to execute the code to cause the apparatus to:
select from a list of neighboring nodes for the node corresponding to the blockchain address.

13. The apparatus of claim 12, wherein:
the list of neighboring nodes is sorted based on an interaction count for each neighbor node to the node corresponding to the blockchain address of the second plurality of blockchain addresses; and
the interaction count is based on the new transaction data.

14. The apparatus of claim 12, wherein:
the list of neighboring nodes is loaded from a distributed file system and the data resulting from the random walk for the node is stored to the distributed file system.

15. The apparatus of claim 12, wherein the one or more processors are individually or collectively further operable to execute the code to cause the apparatus to:
update the first set of node embeddings based at least in part on the data resulting from each random walk that impacts any node embedding of the first set of node embeddings.

16. The apparatus of claim 10, wherein, to generate the second set of node embeddings, the one or more processors are individually or collectively operable to execute the code to cause the apparatus to:
allocate each node of the second plurality of blockchain addresses to a respective subtask, wherein each subtask conducts the random walk for the node; and
combine the data resulting from each random walk for input into the node embedding model.

17. The apparatus of claim 10, wherein:
the transaction data for the first plurality of blockchain addresses is associated with transactions occurring on the blockchain network during a first time period; and
the new transaction data for the second plurality of blockchain addresses is associated with transactions occurring on the blockchain network during a second time period subsequent to the first time period.

18. The apparatus of claim 10, wherein, to compute the risk score, the one or more processors are individually or collectively operable to execute the code to cause the apparatus to:
compute the risk score for each blockchain address using a random forest classifier and set of behavioral features.

19. A non-transitory computer-readable medium storing code for calculating risk scores for blockchain addresses, the code comprising instructions executable by one or more processors to:
generate, using a graph representation of a blockchain network and a node embedding model, a first set of node embeddings for a first plurality of blockchain addresses of the blockchain network using transaction data associated with transactions occurring on the blockchain network by the first plurality of blockchain addresses; and
generate, using the graph representation of the blockchain network, a second set of node embeddings for a second plurality of blockchain addresses that are associated with new transaction data since generation of the first set of node embeddings, wherein generating the second set of node embeddings comprises:
executing, for each node corresponding to a blockchain address of the second plurality of blockchain addresses, a random walk across a set of nodes starting with the node using the transaction data for the set of nodes;
inputting data resulting from the random walk for each node of the second plurality of blockchain addresses into the node embedding model, the inputting resulting in the node embedding model generating the second set of node embeddings; and
computing, using at least the second set of node embeddings, a risk score for each blockchain address of the second plurality of blockchain addresses.

20. The non-transitory computer-readable medium of claim 19, wherein the instructions to execute the random walk for a node corresponding to the blockchain address of the second plurality of blockchain addresses are executable by the one or more processors to:
randomly select, starting with the node, the set of nodes that are neighboring nodes based on one or more parameters.
